(19) United States
(12) Patent Application Publication
(10) Pub. No.: US 2014/0379360 A1
(43) Pub. Date: Dec. 25, 2014

(54) LOW GLUCOSE TREATMENT FOR PEOPLE WITH DIABETES

(71) Applicant: LifeScan, Inc., Milpitas, CA (US)

(72) Inventors: Shawn BERVEN, Philadelphia, PA (US); Sweta CHOVANDA, Exton, PA (US)

(21) Appl. No.: 13/927,067

(22) Filed: Jun. 25, 2013

(51) Int. Cl. G06F 19/00

(52) U.S. Cl. CPC G06F 19/3475
USPC 705/2

(57) ABSTRACT

Described are methods and systems to allow persons with diabetes to determine the most optimal treatment for low blood glucose or hypoglycemia, which conditions affect each diabetic differently. Because each individual's body reacts differently to each of the treatment options proposed by the HCP, embodiments of this invention will allow the user to find the most effective treatment for hypoglycemia tailored to the particular user. This inventive solution helps them to remember the options that worked best, and over a period of time during operation of the invention learns to present only those options that work best.

### BACKGROUND

Diabetes mellitus is a chronic metabolic disorder caused by an inability of the pancreas to produce sufficient amounts of the hormone drug so that the metabolism is unable to provide for the proper absorption of sugar and starch. This failure leads to hyperglycemia, i.e. the presence of an excessive amount of analyte within the blood plasma. Persistent hyperglycemia has been associated with a variety of serious symptoms and life threatening long term complications such as dehydration, ketoacidosis, diabetic coma, cardiovascular diseases, chronic renal failure, retinal damage and nerve damages with the risk of amputation of extremities. Because healing is not yet possible, a permanent therapy is necessary which provides constant glycemic control in order to always maintain the level of blood analyte within normal limits. Such glycemic control is achieved by regularly supplying external drug to the body of the patient to thereby reduce the elevated levels of blood analyte.

External drug was commonly administered by means of multiple, daily injections of a mixture of rapid and intermediate acting drug via a hypodermic syringe. While this treatment does not require the frequent estimation of blood analyte, it has been found that the degree of glycemic control achievable in this way is suboptimal because the delivery is unlike physiological drug production, according to which drug enters the bloodstream at a lower rate and over a more extended period of time. Improved glycemic control may be achieved by the so-called intensive drug therapy which is based on multiple daily injections, including one or two injections per day of long acting drug for providing basal drug and additional injections of rapidly acting drug before each meal in an amount proportional to the size of the meal. Although traditional syringes have at least partly been replaced by drug pens, the frequent injections are nevertheless very inconvenient for the patient, particularly those who are incapable of reliably self-administering injections.

Substantial improvements in diabetes therapy have been achieved by the development of the drug delivery device, relieving the patient of the need for syringes or drug pens and the administration of multiple, daily injections. The drug delivery device allows for the delivery of drug in a manner that bears greater similarity to the naturally occurring physiological processes and can be controlled to follow standard or individually modified protocols to give the patient better glycemic control.

In addition delivery directly into the intraperitoneal space or intravenously can be achieved by drug delivery devices. Drug delivery devices can be constructed as an implantable device for subcutaneous arrangement or can be constructed as an external device with an infusion set for subcutaneous infusion to the patient via the transcutaneous insertion of a catheter, cannula or a transdermal drug transport such as through a patch. External drug delivery devices are mounted on clothing, hidden beneath or inside clothing, or mounted on the body and are generally controlled via a user interface built-in to the device or on a separate remote device.

Drug delivery devices have been utilized to assist in the management of diabetes by infusing drug or a suitable biologically effective material into the diabetic patient at a basal rate with additional drug or “bolus” to account for meals or high analyte values, levels or concentrations. The drug delivery device is connected to an infuser, better known as an infusion set by a flexible hose. The infuser typically has a subcutaneous cannula, adhesive backed mount on which the cannula is attached thereto. The cannula may include a quick disconnect to allow the cannula and mount to remain in place on the skin surface of the user while the flexible tubing is disconnected from the infuser.

Regardless of the type of drug delivery device, blood analyte monitoring is required to achieve acceptable glycemic control. For example, delivery of suitable amounts of drug by the drug delivery device requires that the patient frequently determines his or her blood analyte level and manually input this value into a user interface for the external pumps, which then calculates a suitable modification to the default or currently in-use drug delivery protocol, i.e. dosage and timing, and subsequently communicates with the drug delivery device to adjust its operation accordingly. The determination of blood analyte concentration is typically performed by means of an episodic measuring device such as a hand-held electronic meter which receives blood samples via enzyme-based test strips and calculates the blood analyte value based on the enzymatic reaction.

Currently, when diabetic users experience ‘Low’ blood glucose, they are expected to treat the condition based on the doctor's advice. There is often more than one suggested treatment option that the user can chose from to treat their low. Not all the options work for every individual and hence there is some amount of trial and error involved.

### SUMMARY OF THE DISCLOSURE

Applicants have devised system in which treatment of the low glucose glycemic condition can be personalized to the user based on user feedback or in addition to objective analysis of the treatment. The HCP (Health Care Professional) can recommend multiple options to treat the condition and the user can list their preferences based on what works for them by choosing an appropriate indicator of the effectiveness of the treatment. The invention aims at helping users better manage their Tow Blood Glucose' condition. It helps with managing their treatment options in a way that it helps them when they absolutely need it. It also provides reassurance to the HCPs that the users are treating themselves the right way at the right time. Over a period of time, this solution will the user understand what works best for his/her body and condition.

In one aspect, system for diabetes management. The system includes a handheld computing unit and a glucose monitor along with glucose biosensors. The glucose monitor unit is configured to measure a glucose level of the user with respective glucose biosensors, the monitor unit configured for bidirectional communication with the computing unit The computing unit includes a microprocessor coupled to a memory and a user interface. The computing unit is programmed to: (a) query the user with questionnaires to determine a type of diabetes of the user; (b) categorize the user with a type of diabetes; (c) configure treatment options for the user for low blood glucose based on the type of diabetes from the categorizing step; (d) present the user with at least one treatment option whenever the glucose monitor provides a low blood glucose value below a predetermined threshold from a glucose measurement taken by the monitor; (e) request the user to indicate whether the user has access to the at least one treatment option for the low blood glucose value; (f) evaluate whether the at least one treatment option was effective based on the user indication to the computing unit; and (g) present an alternate treatment option in the event the user does not have access to the at least one treatment option.

In the above aspect, the following features may be utilized in combination with the above aspect individually or with each other. For example, the computing unit is configured to allow a health-care-provider to input predetermined treatment options depending on the type of diabetes; the predetermined treatment options comprises one of fruit juice, glucose tablet, soft drink, milk, raisins, candies; the at least one treatment option comprises the predetermined treatment options; the unit determines a first location of handheld computing unit and a second location of vendor for the at least one treatment option comprising one of fruit juice, glucose tablet, soft drink, milk, raisins, candies and presenting a navigational map from the first location to the second location; the monitor conducts a glucose measurement within a predetermined time period after selection of treatment option via the computing device with a specific treatment option provided and if the glucose measurement is greater than the threshold then the computing device stores the treatment option as a most preferred option in the memory of the computing device; the computing device ascertains whether the glucose measurement taken after the specific treatment is higher than a predetermined threshold and if true categorize the specific treatment as effective at treating hypoglycemia and if false, categorize the treatment as ineffective; the computing unit requests the user to indicate whether a specific treatment was effective and if confirmed by the user as effective at treating hypoglycemia, categorize the specific treatment as effective in the memory of the computing device; the computing device organizes treatment options that have been categorized as effective for the user based on magnitude of glucose measurement and at least one of location, time, medication and subjective symptoms; and the presentation of an alternate treatment option comprises a display of the treatment options that have been categorized as effective for the user based on magnitude of glucose measurement and at least one of location, time, medication and subjective symptoms.

In another aspect, a method to manage diabetes of a user with a glucose monitor and a handheld computing unit is provided. The glucose monitor is configured to communicate with the handheld computing unit. The method can be achieved by: querying the user with questionnaires to determine a type of diabetes of the user; categorizing the user with a type of diabetes; configuring treatment options for the user for low blood glucose based on the type of diabetes from the categorizing step; measuring a blood glucose of the user with the glucose monitor; in the event the step of measuring indicates a blood glucose value lower than a predetermined threshold, presenting the user with at least one treatment option from the configuring step; requesting the user to indicate whether the user has access to the at least one treatment option; in the event the user indicated that the user has access to the at least one treatment option, evaluating whether the at least one treatment option was effective at reducing or preventing low blood glucose in the user; and in the event the user indicated that the user does not have access to the at least one treatment option, presenting an alternate treatment option.

In a further aspect, the questionnaires may include: requesting the user to select type 1, type 1.5 or type 2 diabetes; in the event the user selects type 1 or type 1.5, requesting the user to indicate the type of insulin and the user's insulin sensitivity factor. Similarly, the configuring step may include permitting a health-care-provider to input predetermined treatment options depending on the type of diabetes. It is noted that the predetermined treatment options may include one of fruit juice, glucose tablet, soft drink, milk, raisins, and candies. Alternatively, the at least one treatment option may include the predetermined treatment options.

In yet another aspect, the method may include determining a first location of handheld computing unit and a second location of vendor for at least one treatment option comprising one of fruit juice, glucose tablet, soft drink, milk, raisins, candies and presenting a navigational map from the first location to the second location. Furthermore, the evaluating may include conducting a glucose measurement within a predetermined time period after selection of treatment option with a specific treatment option and if the glucose measurement is greater than the threshold then storing the treatment option as a most preferred option in the memory of the computing device. Moreover, the method may include ascertaining whether the glucose measurement from the requesting step is higher than a predetermined threshold and if true categorizing the specific treatment as effective at treating hypoglycemia and if false, categorizing the treatment as ineffective. It is noted that the evaluating step may include requesting the user to indicate whether a specific treatment was effective and if confirmed by the user as effective at treating hypoglycemia, categorizing the specific treatment as effective in the memory of the portable computing device. Yet the method may further include organizing treatment options that have been categorized as effective for the user based on magnitude of glucose measurement and at least one of location, time, medication and subjective symptoms. And the presenting of an alternate treatment option may include, displaying the treatment options that have been categorized as effective for the user based on magnitude of glucose measurement and at least one of location, time, medication and subjective symptoms.

In the aforementioned aspects of the disclosure, the steps disclosed may be performed by an electronic circuit or a processor to provide for a technical effect in the art. These steps may also be implemented as executable instructions stored on a computer readable medium; the instructions, when executed by a computer may perform the steps of any one of the aforementioned methods.

These and other embodiments, features and advantages will become apparent to those skilled in the art when taken with reference to the following more detailed description of various exemplary embodiments of the invention in conjunction with the accompanying drawings that are first briefly described.

### BRIEF DESCRIPTION OF THE DRAWINGS

The accompanying drawings, which are incorporated herein and constitute part of this specification, illustrate presently preferred embodiments of the invention, and, together with the general description given above and the detailed description given below, serve to explain features of the invention (wherein like numerals represent like elements).

FIG. 1A illustrates an exemplary embodiment of the diabetic management system.

FIG. 1B illustrates the components for the device 104 of FIG. 1A.

FIG. 2 illustrates the logic for use with the device of FIG. 1B.

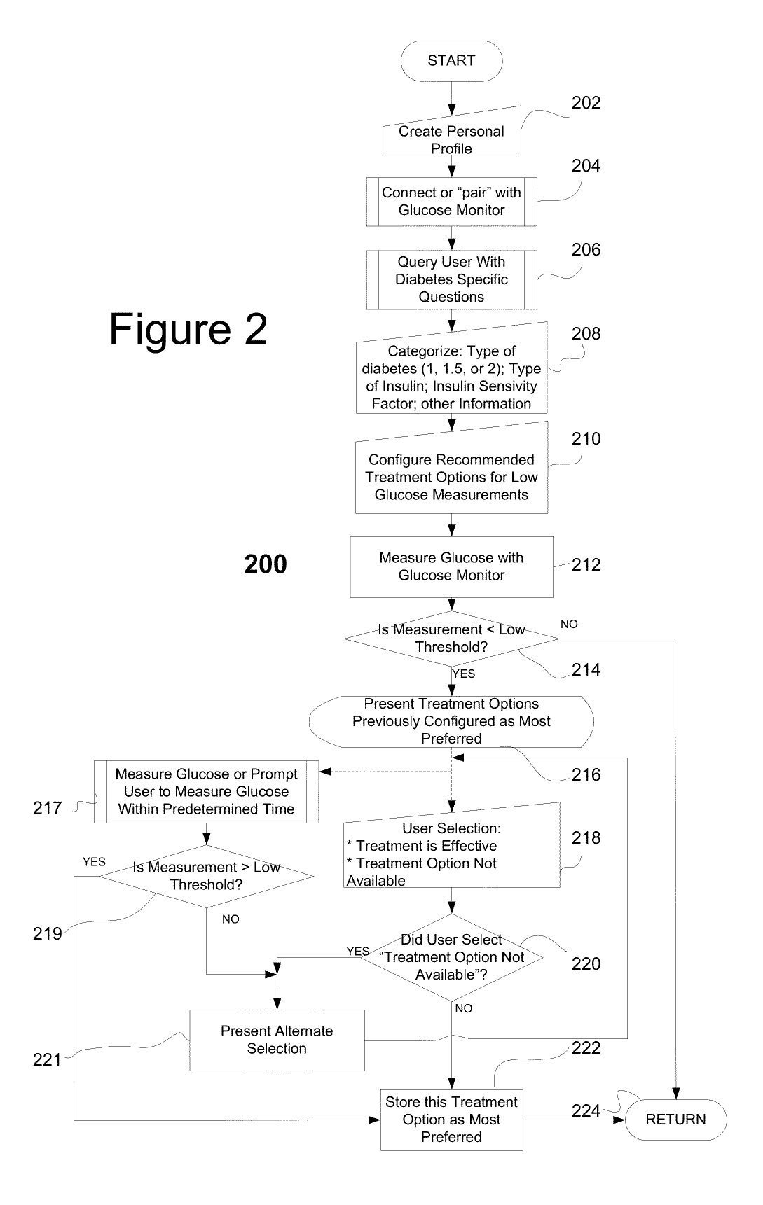

FIG. 3 illustrates exemplary screens during operation of the system.

### MODES FOR CARRYING OUT THE INVENTION

The following detailed description should be read with reference to the drawings, in which like elements in different drawings are identically numbered. The drawings, which are not necessarily to scale, depict selected embodiments and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention.

As used herein, the terms “about” or “approximately” for any numerical values or ranges indicate a suitable dimensional tolerance that allows the part or collection of components to function for its intended purpose as described herein. In addition, as used herein, the terms “patient,” “host,” “user,” and “subject” refer to any human or animal subject and are not intended to limit the systems or methods to human use, although use of the subject invention in a human patient represents a preferred embodiment. Furthermore, the term “user” includes not only the patient using a drug infusion device but also the caretakers (e.g., parent or guardian, nursing staff or home care employee). The term “drug” may include pharmaceuticals or other chemicals that causes a biological response in the body of a user or patient.

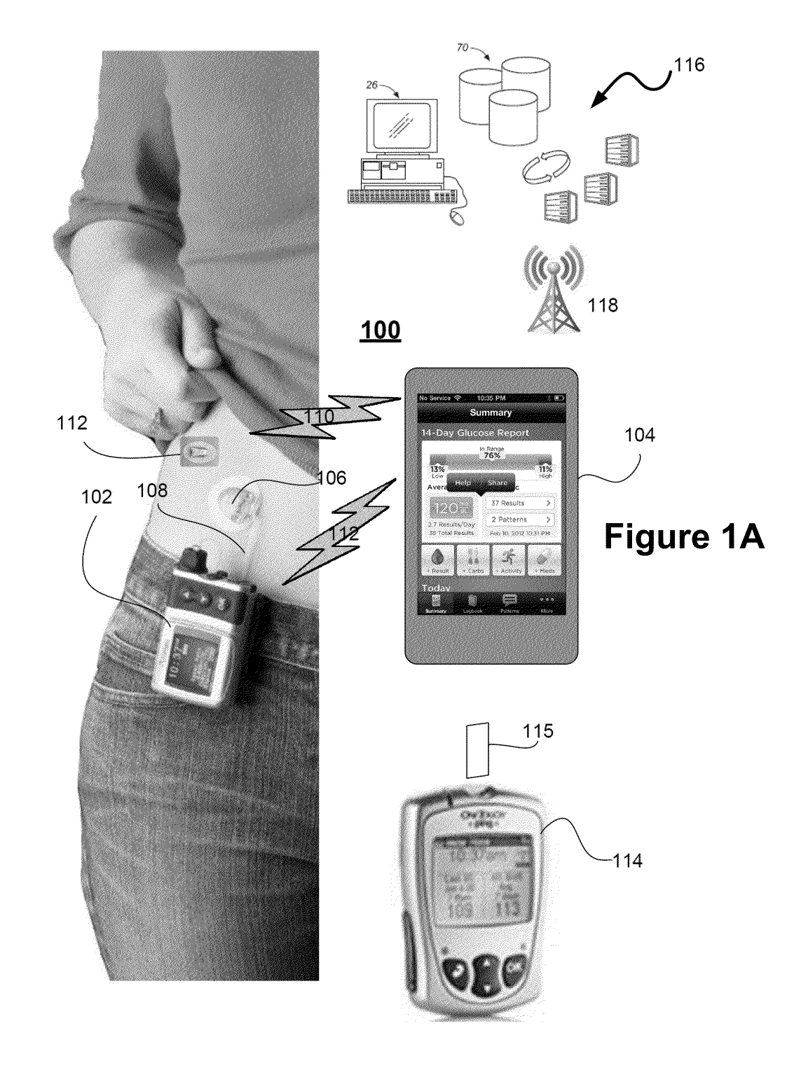

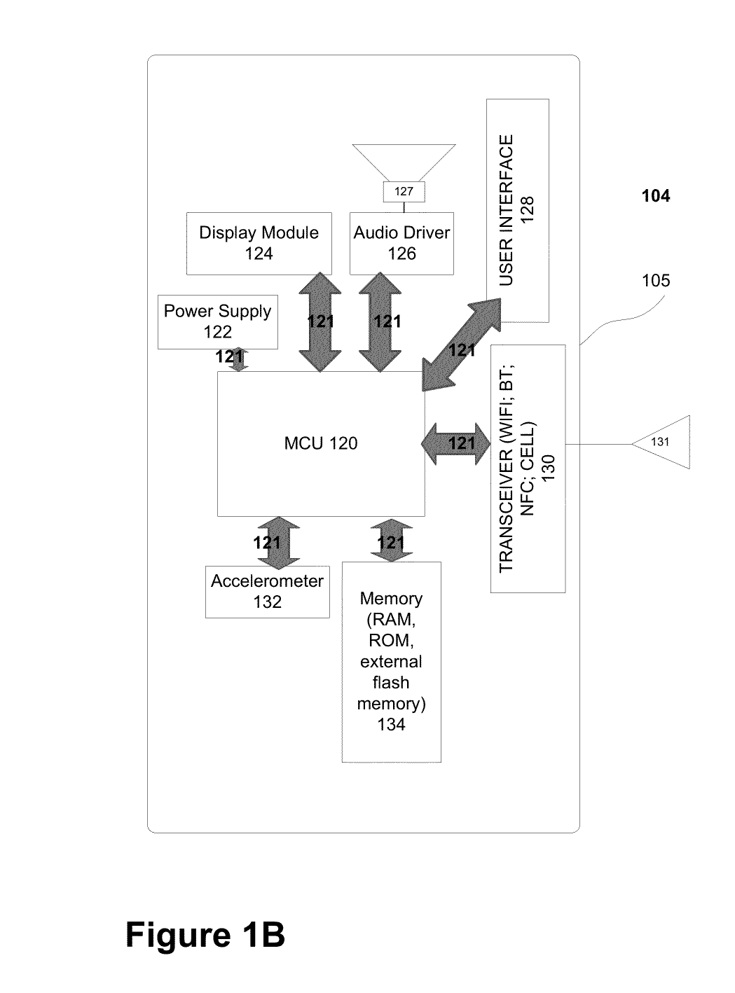

FIG. 1 illustrates a drug delivery system 100 according to an exemplary embodiment. Drug delivery system 100 includes a drug delivery device 102 and a remote controller 104. Drug delivery device 102 is connected to an infusion set 106 via flexible tubing 108.

Drug delivery device 102 is configured to transmit and receive data to and from remote controller 104 by, for example, radio frequency communication 110. Drug delivery device 102 may also function as a stand-alone device with its own built in controller. In one embodiment, drug delivery device 102 is a drug infusion device and remote controller 104 is a hand-held portable controller. In such an embodiment, data transmitted from drug delivery device 102 to remote controller 104 may include information such as, for example, drug delivery data, blood glucose information, basal, bolus, insulin to carbohydrates ratio or insulin sensitivity factor, to name a few. The controller 104 may be configured to receive continuous analyte readings from a continuous analyte (“CGM”) sensor 112. Data transmitted from remote controller 104 to drug delivery device 102 may include analyte test results and a food database to allow the drug delivery device 102 to calculate the amount of drug to be delivered by drug delivery device 102. Alternatively, the remote controller 104 may perform dosing or bolus calculation and send the results of such calculations to the drug delivery device. In an alternative embodiment, an episodic blood analyte meter 114 may be used alone or in conjunction with the CGM sensor 112 to provide data to either or both of the controller 102 and drug delivery device 102. Alternatively, the remote controller 104 may be combined with the meter 114 into either (a) an integrated monolithic device; or (b) two separable devices that are dockable with each other to form an integrated device. Each of the devices 102, 104, and 114 has a suitable micro-controller (not shown for brevity) programmed to carry out various functionalities. For example, a microcontroller can be in the form of a mixed signal microprocessor (MSP) for each of the devices 102, 104, or 114. Such MSP may be, for example, the Texas Instrument MSP 430, as described in patent application publication numbers US2010-0332445, and US2008-0312512 which are incorporated by reference in their entirety herein and attached hereto the Appendix of this application. The MSP 430 or the pre-existing microprocessor of each of these devices can be configured to also perform the method described and illustrated herein.

Drug delivery device 102 may also be configured for bi-directional wireless communication with a remote health monitoring station 116 through, for example, a wireless communication network 118. Remote controller 104 and remote monitoring station 116 may be configured for bi-directional wired communication through, for example, a telephone land based communication network. Remote monitoring station 116 may be used, for example, to download upgraded software to drug delivery device 102 and to process information from drug delivery device 102. Examples of remote monitoring station 116 may include, but are not limited to, a personal or networked computer, a personal digital assistant, other mobile telephone, a hospital base monitoring station or a dedicated remote clinical monitoring station.

Drug delivery device 102 includes processing electronics including a central processing unit and memory elements for storing control programs and operation data, a radio frequency module 116 for sending and receiving communication signals (i.e., messages) to/from remote controller 104, a display for providing operational information to the user, a plurality of navigational buttons for the user to input information, a battery for providing power to the system, an alarm (e.g., visual, auditory or tactile) for providing feedback to the user, a vibrator for providing feedback to the user, a drug delivery mechanism (e.g. a drug pump and drive mechanism) for forcing a drug from a drug reservoir (e.g., a drug cartridge) through a side port connected to an infusion set 106 and into the body of the user.

The portable handheld communication unit 104 may include interface buttons and the buttons may be mechanical/electrical switches; however, a touch screen interface with virtual buttons is also utilized. As shown in FIG. 1B, the electronic components of the portable handheld communication unit 104 can be disposed on, for example, a printed circuit board situated within a housing 105 and forming the portable handheld communication unit 104 described herein. FIG. 1B illustrates, in simplified schematic form, several of the electronic components disposed within the housing 105 for purposes of this embodiment. The handheld portable communication device 104 includes a processing unit 120 in the form of a microprocessor, a microcontroller, an application specific integrated circuit (“ASIC”), a mixed signal processor (“MSP”), a field programmable gate array (“FPGA”), or a combination thereof, and is electrically connected to various electronic modules included on, or connected to, the printed circuit board, as will be described below. The processing unit 120 is electrically connected to, for example, a transceiver 130 over a communication path 121, the transceiver being connected to an antenna 131 which receives the aforementioned transmitted glucose measurement information from the glucose sensor.

A display module 124, which may include a display processor and display buffer, is electrically connected to the processing unit 120 over the communication path 121 for receiving and displaying output data as described above, and for displaying user interface input options under control of processing unit 120. The structure of the user interface, such as menu options, is stored in user interface module 128 and is accessible by the processing unit 120 for presenting menu options to a user of the portable handheld communication unit 104. An audio module 126 includes a speaker 127 for outputting audio data received or stored by the DMU 150. Audio outputs can include, for example, notifications, reminders, tones, and alarms, or may include audio data to be replayed in conjunction with display data presented on the display 14. For example, stored audio data may include voice data which, when replayed over speaker 127, can be heard by the user and may include helpful instructions, alerts, or other information. Such stored audio data can be accessed by the processing unit 120 and executed as playback data at appropriate times. A volume of the audio output is controlled by the processing unit 120 under programmed control, and the volume setting can be stored in driver 126, as determined by the processor or as adjusted by the user. One of the algorithms included in a volume control program may be a procedure for increasing a volume of an audible alert indicator up to a maximum volume of the included speaker or until a programmed alert period expires. Although not shown, the audio module 126 may be connected to a motor for outputting alerts, alarms, or reminders in the form of a vibratory output or to otherwise notify the user during times when the audio is turned off User input module 128 receives inputs via user interfaces which are received and transmitted to the processing unit 120 over the communication path 121. Although not shown in FIG. 1B, the processing unit 120 has electrical access to a digital time-of-day clock connected to the printed circuit board for recording dates and times of periodic glucose measurements received from the glucose sensor, which may then be accessed, uploaded, or displayed as necessary. Associated with the clock is a timer for recording elapsed times, preset or predetermined time delays under programmed control of the processing unit 120.

The display of the module 124 can alternatively include a backlight and the brightness of the display backlight may be controlled by the processing unit 120 via a light source control module. A memory module 134, that includes but is not limited to volatile random access memory (“RAM”), a non-volatile memory, which may comprise read only memory (“ROM”) or flash memory, and a circuit for connecting to an external portable memory device port, is electrically connected to the processing unit 120 over a communication path 121. External memory devices may include flash memory devices housed in thumb drives, portable hard disk drives, data cards, or any other form of electronic storage devices. The on-board memory can include various embedded and default applications executed by the processing unit 120 for operation of the portable handheld communication unit 104, as will be explained below. On board memory can also be used to store a history of a user's glucose measurements including dates and times associated therewith which may be displayed as illustrated in FIG. 1A. Using the wireless transmission capability of the portable handheld communication unit 104, as described below, such measurement data can be transferred via wired or wireless transmission to connected computers or other processing devices.

A wireless module 130 may include transceiver circuits for wireless digital data transmission and reception via one or more internal digital antennas 131, and is electrically connected to the processing unit 120 over communication path 121. The wireless transceiver circuits may be in the form of integrated circuit chips, chipsets, programmable functions operable via processing unit 120, or a combination thereof. Each of the wireless transceiver circuits is compatible with a different wireless transmission standard. For example, a wireless transceiver circuit 108 may be compatible with the Wireless Local Area Network IEEE 802.11 standard known as WiFi. Transceiver circuit 108 is configured to detect a WiFi access point in proximity to the portable handheld communication unit 104 and to transmit and receive data from such a detected WiFi access point. A wireless transceiver circuit 130 may be compatible with the Bluetooth protocol and is used by the processing unit 120 to detect and synchronize with BlueTooth compatible devices in proximity to the continuous portable handheld communication unit 104. The user may choose to synchronize the portable handheld communication unit 104 with a cell phone, a tablet computer, or other computing device, thereby automatically establishing a Bluetooth communication channel, or other RF wireless communication channel, between the continuous portable handheld communication unit 104 and one or more other computing devices when they are within range of each other. The wireless transceiver circuit 130 may also be configured to receive and process data transmitted over a preselected communication channel from the glucose sensor worn by the user, which channel may include a Bluetooth communication channel if the sensor includes a BlueTooth capability. A wireless transceiver circuit 130 may be compatible with the near field communication (“NFC”) standard and is configured to establish radio communication with, for example, any NFC compliant device in proximity to the portable handheld communication unit 104. A wireless transceiver circuit 130 may comprise a circuit for cellular communication with cellular networks and is configured to detect and link to available cellular communication towers.

A power supply module 122 is electrically connected to all modules in the housing 105 and to the processing unit 120 to supply electric power thereto. The power supply module 122 may comprise standard or rechargeable batteries or an AC power supply may be activated when the portable handheld communication unit 104 is connected to a source of AC power. The power supply module 122 is also electrically connected to the processing unit 120 over the communication path 121 such that processing unit 120 can monitor a power level remaining in a battery power mode of the power supply module 122. Although the device 104 has been described herein insofar as it is used within portable handheld communication unit 104, it should be noted that similar functions using similar circuitry may also be provided in the various communication devices described herein, such as cellular phones, such as smart phones, tablet computers and other communication devices, described below, containing processing systems.

The portable handheld communication unit 104 may also include at least one position sensor, such as an accelerometer 132 electrically connected to the processing unit 120, which is capable of indicating a severe change in attitude in the monitor. This change in attitude could be representative of a more serious condition of the user; e.g., that the user has possibly collapsed due to a hypoglycemic event. Another indication from the accelerometer may result in determining that the monitor is not in motion, or has not been in motion for a period of time, and therefore that the user may not capable of responding to an alert indicator. Thus, the processing unit 120 of the portable handheld communication unit 104 may use such indications from the accelerometer 132 to determine a severity of the alert condition.

Applicant has devised a logical process 200 for operating the system described in FIG. 1A. Specifically, the process 200 starts at step 202 whereby a personal profile for the user can be created on the device 104. The personal profile may start with a series of questions and answers relating to the user's biometric information such as, for example, name, age, weight, height, address, phone number, physician's contact information and emergency contact information. Once the personal profile has been created, the device 104 can connect with a suitable glucose monitor, such as, for example, a CGM-type 112 or an episodic glucose monitor 114 (“BGM”). The pairing process can be via the Bluetooth pairing process in which the user would enter a code specific to the CGM 112 or BGM 114. Alternatively, the pairing process can be much more rigorous as shown and described in US Patent Application Publication No. 20080312585, which is incorporated by reference herein. At step 206, the device 104 may now query the user with questions relating to diabetes in order to ensure that the appropriate treatment options are set up correctly in the system. The questions may include, for example, “WHAT TYPE OF DIABETES DO YOU HAVE?” and presenting a list of check boxes for “TYPE 1”; “TYPE 1.5” (also known as latent autoimmune diabetes of adults); AND “TYPE 2”; “WHAT TYPE OF INSULIN ARE YOU USING?” and presenting a list of insulin names (e.g., Humalog, Lispro, Novolog or Aspart, Apidra or Glulisine, Humulin or Novolin, NPH, Lente, Ultralente, Lantus, Levemir, Humulin 70/30, Novolin 70/30, Novolog 70/30, Humulin 50/50, Humalog 75/25) with check boxes or a list of Long-Acting insulin, Rapid-Acting, Short-Acting, Intermediate-Acting, or Pre-Mixed; or for example, a query: “WHAT IS YOUR INSULIN SENSITIVITY FACTOR?” and presenting a dialog box for the user to enter the appropriate value. Once the user has answered these questions at step 206, the system will then categorize, at step 208, the specificity of the type of diabetes of the user. For added safety, the device may query the physician to confirm the category of the user's diabetes. Alternatively, the device may communicate directly with the electronic medical records of the patient at the physician's office to confirm the same. At step, 210, the system will then configure the user to the appropriate treatment options for low blood glucose based on the type of diabetes determined or confirmed from the categorizing step 208. The configuration step 210 can be any recommendations provided by the user's health-care-provider (HCP) and loaded into the device 104. Where the HCP has not entered the recommendations, the recommendations (e.g., 15 grams of carbohydrates in the form of 4 oz of juice or soda, 2 tablespoon of raisins, 5 saltine crackers, 4 teaspoon of sugar, 1 tablespoon of honey) by the American Diabetes Association can be programmed into the device as default recommendations. At step 212, the glucose monitor, e.g., CGM 112, can measure the glucose level of the user as part of the diabetes management. Alternatively, the user can measure the glucose using a BGM 114 and the measured value can be transmitted to the device 104. At step 214, the measurement is compared against a pre-configured (or preset) threshold, such as for example, 60 mg/dL. If the measured value is greater than or equal to the low threshold, the logic returns to the main sub-routine at 224 because there is no indication of a low blood glucose event. On the other hand, if the measured value is less than the preset low threshold, then the logic moves from 214 to step 216 in which the system presents treatment options that were configured as most preferred. If step 216 is the first time, the treatment options could be the preloaded treatment options. From step 216, there are two alternate paths. The first path would move to step 218 in which the user is asked to indicate (a) if the treatment is effective in preventing or ameliorating a low blood glucose event; or (b) the treatment option is not available to the user at the moment. At step 220, a query would be made to determine if the user selected the “TREATMENT NOT AVAILABLE” selection and if true, the logic would present another alternative treatment option at step 221. On the other hand, if the user did not make the “TREATMENT NOT AVAILABLE” selection, it will be assumed by the system that this treatment was effective. Thereafter, at step 222, the last used treatment option is stored as the most preferred treatment option in the system in that such treatment will be presented the next time there is a low blood glucose measurement.

Returning back to step 216, instead of relying on the user to confirm the effectiveness (or the lack thereof) the selected treatment option, the system could determine whether the treatment was effective objectively checking the user's glucose within a predetermined time period after a low measurement was determined In particular, at step 217, the system could request the user to perform a glucose measurement or the system could automatically perform one or more by virtue of the CGM 112 in its normal operation. Where the user is requested to measure the glucose, the monitor 114 can be utilized along with the biosensor 115. Where the system is using the CGM 112, the measured glucose values would be the glucose values that are taken at the predetermined time interval (e.g., 5 minutes) for the CGM 112 at the predetermined time after the initial low glucose measurements of step 212. At step 219, the system checks to see if this post-low glucose measurement (either the CGM 112 or BGM 114) is above the low threshold and if true then it can be inferred by the system that this particular treatment is objectively effective and stored in step 222. Thereafter, the logic moves to return to the main routine at step 224.

On the other hand, if the query at step 219 indicates that no, the post-low glucose measurement made at 217 is not greater (i.e., meaning the measured glucose value is lower than the low threshold) then the system presents an alternate selection at step 221.

To recap, the system may evaluate the effectiveness of the recommended treatment by conducting a glucose measurement within a predetermined time period after selection of treatment option with a specific treatment option. In the glucose measurement made after application of the treatment, if the glucose measurement is greater than the low threshold then the system stores the treatment option as a most preferred option in the memory of the computing device 104. Hence, as part of our inventive concept or technical contribution to the field, the system ascertains as to whether the glucose measurement from the requesting step 217 is higher than a predetermined threshold and if true, the system categorizes the specific treatment as effective at treating hypoglycemia and if false, it categorizes the treatment as ineffective. In the alternative, or even in conjunction to the objective post-low glucose measurement of step 212, the system may request the user to indicate whether a specific treatment was effective. If confirmed by the user as effective at treating hypoglycemia, the system may categorize the specific treatment as effective subjectively in the memory of the portable computing device.

It should be noted that at step 210, the HCP can be permitted to provide treatment options as inputs into the system and whose treatment options may be different from predetermined treatment options. The predetermined treatment options can include, for example, one of fruit juice, glucose tablet, soft drink, milk, raisins, and candies.

Where the device 104 is provided with a GPS receiver or geo-location device, the device 104 is programmed to query search engine such as, for example, Google, to determine whether one or more of the treatment items are available at a vendor or supply near the user. Specifically, the system may determine a first location of the handheld computing unit and a second location of vendor for the at least one treatment option, in which the treatment option may be a standard one of fruit juice, glucose tablet, soft drink, milk, raisins, candies and presenting a navigational map from the first location to the second location for the user to obtain the alternative treatment options.

The system can be configured to organize treatment options that have been categorized as effective for the user based on magnitudes of glucose measurement and at least one of location, time, medication and subjective symptoms. For example, a look-up table, such as a Table below can be generated by the system based on these factors to allow for determination of the most optimal treatment. In the look-up Table, the system may determine from a scoring of several factors. In the exemplary Table, the system begins by determining if the blood glucose is below a first low threshold (e.g., 60 mg/dL) or a second low threshold (e.g., 50 mg/dL). Next, the system determines from the GPS where the user is at with respect to the user's home. Depending on the user's experience and duration of diabetes, the home is probably the best place with the necessary equipment for handling a hypoglycemic event. In contrast, being outside the home will present challenges to the user undergoing such a glycemic event. The system would use the location determination to determine where the user is. Then, based on preset location settings, the app would propose a specific treatment based on the pre-set locations. For example, if the preset location is the user's car, the treatment proposed when the system has detected that the user is in the user's car is glucose tablets because the user previously specified to present glucose tabs when travelling. In the house, the proposed treatment would be juice, because the user specified suggesting juice when at home. Even with these presets, complications remain as to whether the user has taken insulin (bolus or basal), metformin or other drugs that affect glucose metabolism in the user. Thus, the Table can be populated with preset settings or user-generated settings. Subsequently, as the user and system learn the effectiveness of the treatment options, the treatment can be tailored to fit specific needs of the user.

| | Location- | | |
|---|---|---|---|
| | automatically | | |
| | configured | | |
| | by the | | |
| | system prior | | Treatment Option |
| | to presentation | | Categorized as Effective |
| Last Glucose | of treatment | Medication | (or Preset Treatment |
| Measurement | option(s) | Taken | Options) |
| Below 60 | Outside of | No Insulin | Fruit Juice-4 oz or two |
| mg/dL | home | bolus or basal | pieces of candy. |
| | | in the last 3 | Additional Information- |
| | | hours | Ask the user if they |
| | | | would like to see the |
| | | | route map to nearest |
| | | | food store; store record |
| | | | of glycemic event with |
| | | | date, time and other |
| | | | information for later |
| | | | analysis. |
| Below 50 | Home | No Insulin | Two tablespoon of sugar |
| mg/dL | | bolus or basal | and Test Glucose in 30 |
| | | in the last 3 | minutes; text to HCP or |
| | | hours | designated person with |
| | | | record of time, date, and |
| | | | other data regarding this |
| | | | glycemic event. |
| Below 50 | Outside of | No Insulin | One soda 16 oz. or |
| mg/dL | Home | bolus in the | glucose tablets and test |
| | | last 3 hours | in 15 minutes; display |
| | | | route map to nearest |
| | | | food store; text to HCP |
| | | | (or designated person) |
| | | | with record of time, |
| | | | date, and other data |
| | | | regarding this glycemic |
| | | | event. |
| Below 60 | Home | Insulin bolus | Glucagon Pen and text |
| mg/dL | | in the last 3 | to HCP with record of |
| | | hours | time, date, and other |
| | | | data regarding this |
| | | | glycemic event. |
| Below 60 | Outside of | Insulin bolus | Glucagon Pen and |
| mg/dL | Home | in the last 3 | Glucose Tablet and |
| | | hours | emergency call to |
| | | | caretaker or HCP; text |
| | | | message to HCP with |
| | | | record of time, date, and |
| | | | other data regarding this |
| | | | glycemic event. |
| Below 50 | Home | Insulin bolus | Glucagon Pen, Glucose |
| mg/dL | | in the last 3 | Table and Emergency |
| | | hours | Call to caretaker HCP, |
| | | | text to HCP with record |
| | | | of time, date, and other |
| | | | data regarding this |
| | | | glycemic event. |

Although one example has been shown in the Table above, it is intended by applicant that other techniques can be utilized to help the user achieve personalized low glucose treatment. For example, an array can be devised in the device 104 to assign points to each of the factors and for each incidence of a glycemic event, the treatment with the highest points can be utilized to treat the low blood glucose, depending on the severity of the glycemic condition of the user. The symptoms of the user can be assigned negative points, depending on the severity and a summation can be made with the treatment option that nets a zero value. Because of the number of factors involved, the portable computing device is best suited to help the user navigate the various treatment options, which may be so numerous that a person skilled in the art would not be able to determine the appropriate treatment options.

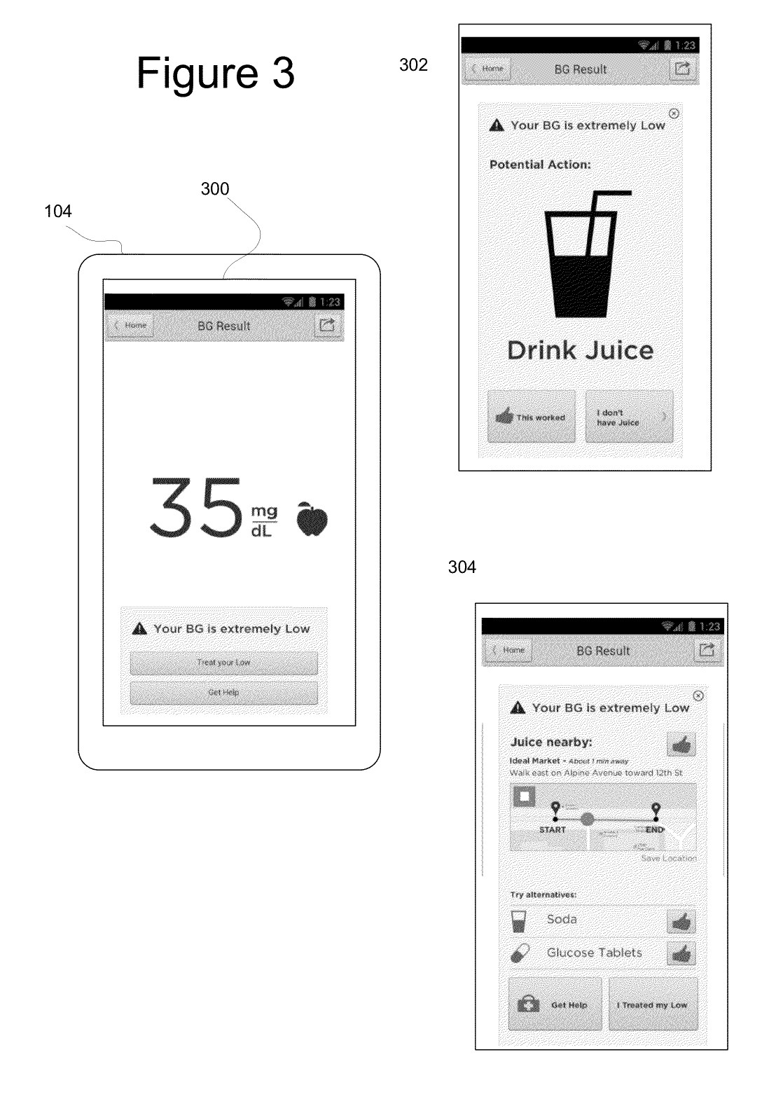

In one operational example, as described in relation to FIG. 3, it is assumed that the glucose monitor (CGM 112 or BGM 114) has measured low blood glucose for the user (at step 212). This low measurement would immediately be brought to the attention of the user via screen 300. In screen 300, the measurement would be displayed as an actual value at 300a. If the measurement was made after a meal, the appropriate after meal icon 300b can be provided. A text message 300c is provided. Depending on the setup of the device, a text message can also be sent to a caretaker of the user. Additional alarms can be set to activate concurrently with the message 300c. The message 300c can include a dialog button “Treat Your Low” for the user to activate. Once the user has tapped on this button, the preferred treatment option is shown to user. If this action was a first use, the treatment option would be based on a list entered or selected by the HCP. If this was subsequent to the first use, the treatment option can be based on tracked usage. At this point user can choose to follow the recommended treatment option. If the treatment appears to work for the user, the user can click the ‘This worked’ button. If the user does not have access to that suggested treatment option, i.e., juice in screen 302, the user can click the ‘I don't have the recommended treatment option’ button. This will allow the user to see alternative treatment options (screen 304). Assuming the user has clicked on the “I don't have juice button” then the system determines if the juice or an equivalent alternative is geographically located nearby. If available via a suitable search engine (e.g., Google) or even an Internet service such as Yelp, the location where juice can be obtained is given. As well, additional alternate treatment options are shown to the user as well in screen 304 (“glucose tablets”). The alternative treatment options are based on the treatment option list and also the treatment option tracking which will place the treatment that has been effective as the most preferential in the list of options.

As noted earlier, low blood glucose (i.e., “hypoglycemia”) is a serious condition and requires immediate treatment. In some situations, the user may be unable to treat himself/herself. If the user doesn't tap a button to indicate that a treatment worked, the phone remains on with the treatment screen visible. This allows for caregivers or bystanders to see the treatment option so they can either help the user or get help for them.

Moreover, because each individual's body reacts differently to each of the treatment options proposed by the HCP, this invention will allow the user to find the most effective treatment for hypoglycemia tailored to the particular user. This inventive solution helps them to remember the options that worked best, and over a period of time during operation of the invention learns to present only those options that work best. This helps to treat the condition of hypoglycemia effectively.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit,” “circuitry,” “module,” and/or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible, non-transitory medium that can contain, or store a program for use by or in connection with an instruction execution system, apparatus, or device.

Program code and/or executable instructions embodied on a computer readable medium may be transmitted using any appropriate medium, including but not limited to wireless, wired, optical fiber cable, RF, etc., or any suitable combination of the foregoing.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Furthermore, the various methods described herein can be used to generate software codes using off-the-shelf software development tools such as, for example, Object Oriented Programming, Visual Studio 6.0, C or C++ (and its variants), Windows 2000 Server, and SQL Server 2000. The methods, however, may be transformed into other software languages depending on the requirements and the availability of new software languages for coding the methods.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. Therefore, to the extent there are variations of the invention, which are within the spirit of the disclosure or equivalent to the inventions found in the claims, it is the intent that this patent will cover those variations as well.

What is claimed is:

1. A system for diabetes management, the system comprising:
a handheld computing unit including a microprocessor coupled to a memory and a user interface;
a glucose monitor unit configured to measure a glucose level of the user with respective glucose biosensors, the monitor unit configured for bidirectional communication with the computing unit, the computing unit being programmed to:
(a) query the user with questionnaires to determine a type of diabetes of the user;
(b) categorize the user with a type of diabetes;
(c) configure treatment options for the user for low blood glucose based on the type of diabetes from the categorizing step;
(d) present the user with at least one treatment option whenever the glucose monitor provides a low blood glucose value below a predetermined threshold from a glucose measurement taken by the monitor;
(e) request the user to indicate whether the user has access to the at least one treatment option for the low blood glucose value;
(f) evaluate whether the at least one treatment option was effective based on the user indication to the computing unit; and
(g) present an alternate treatment option in the event the user does not have access to the at least one treatment option.

2. The system of claim 1, in which the computing unit is configured to allow a health-care-provider to input predetermined treatment options depending on the type of diabetes.

3. The system of claim 1, in which the predetermined treatment options comprises one of fruit juice, glucose tablet, soft drink, milk, raisins, candies.

4. The system of claim 1, in which the at least one treatment option comprises the predetermined treatment options.

5. The system of claim 1, in which the unit determines a first location of handheld computing unit and a second location of vendor for the at least one treatment option comprising one of fruit juice, glucose tablet, soft drink, milk, raisins, candies and presenting a navigational map from the first location to the second location.

6. The system of claim 1, in which the monitor conducts a glucose measurement within a predetermined time period after selection of treatment option via the computing device with a specific treatment option provided and if the glucose measurement is greater than the threshold then the computing device stores the treatment option as a most preferred option in the memory of the computing device.

7. The system of claim 1, in which the computing device ascertains whether the glucose measurement taken after the specific treatment is higher than a predetermined threshold and if true categorize the specific treatment as effective at treating hypoglycemia and if false, categorize the treatment as ineffective.

8. The system of claim 1, in which the computing unit requests the user to indicate whether a specific treatment was effective and if confirmed by the user as effective at treating hypoglycemia, categorize the specific treatment as effective in the memory of the computing device.

9. The system of claim 1, in which the computing device organizes treatment options that have been categorized as effective for the user based on magnitude of glucose measurement and at least one of location, time, medication and subjective symptoms.

10. The system of claim 1, in which the presentation of an alternate treatment option comprises a display of the treatment options that have been categorized as effective for the user based on magnitude of glucose measurement and at least one of location, time, medication and subjective symptoms.

11. A method to manage diabetes of a user with a glucose monitor and a handheld computing unit, the glucose monitor configured to communicate with the handheld computing unit, the method comprising the steps of:
querying the user with questionnaires to determine a type of diabetes of the user;
categorizing the user with a type of diabetes;
configuring treatment options for the user for low blood glucose based on the type of diabetes from the categorizing step;
measuring a blood glucose of the user with the glucose monitor;
in the event the step of measuring indicates a blood glucose value lower than a predetermined threshold, presenting the user with at least one treatment option from the configuring step;
requesting the user to indicate whether the user has access to the at least one treatment option;
in the event the user indicated that the user has access to the at least one treatment option, evaluating whether the at least one treatment option was effective at reducing or preventing low blood glucose in the user; and
in the event the user indicated that the user does not have access to the at least one treatment option, presenting an alternate treatment option.

12. The method of claim 11, in which the querying with the questionnaires comprises:
requesting the user to select type 1, type 1.5 or type 2 diabetes;
in the event the user selects type 1 or type 1.5, requesting the user to indicate the type of insulin and the user's insulin sensitivity factor.

13. The method of claim 11, in which the configuring step comprises:
permitting a health-care-provider to input predetermined treatment options depending on the type of diabetes.

14. The method of claim 13, in which the predetermined treatment options comprises one of fruit juice, glucose tablet, soft drink, milk, raisins, candies.

15. The method of claim 14, in which the at least one treatment option comprises the predetermined treatment options.

16. The method of claim 11, further comprising determining a first location of handheld computing unit and a second location of vendor for the at least one treatment option comprising one of fruit juice, glucose tablet, soft drink, milk, raisins, candies and presenting a navigational map from the first location to the second location.

17. The method of claim 11, in which the evaluating comprises conducting a glucose measurement within a predetermined time period after selection of treatment option with a specific treatment option and if the glucose measurement is greater than the threshold then storing the treatment option as a most preferred option in the memory of the computing device.

18. The method according to claim 17, further comprising ascertaining whether the glucose measurement from the requesting step is higher than a predetermined threshold and if true categorizing the specific treatment as effective at treating hypoglycemia and if false, categorizing the treatment as ineffective.

19. The method of claim 17, in which the evaluating comprises requesting the user to indicate whether a specific treatment was effective and if confirmed by the user as effective at treating hypoglycemia, categorizing the specific treatment as effective in the memory of the portable computing device.

20. The method of claim 19, further comprising organizing treatment options that have been categorized as effective for the user based on magnitude of glucose measurement and at least one of location, time, medication and subjective symptoms.

21. The method of claim 11, in which the presenting of an alternate treatment option comprises, displaying the treatment options that have been categorized as effective for the user based on magnitude of glucose measurement and at least one of location, time, medication and subjective symptoms.
